(19) United States
(12) Patent Application Publication
(10) Pub. No.: US 2004/0006537 A1
(43) Pub. Date: Jan. 8, 2004

(54) Method and system for processing credit card related transactions

(75) Inventors: Peter M. Zelechoski, Elkhorn, NE (US); Rex Johnson, Omaha, NE (US); Richard McKie, Waterloo, NE (US); Tom Lima, Omaha, NE (US); Steve Joyce, Omaha, NE (US); Kent Parkison, Clive, IA (US); Norman T. Davis, Elkhorn, NE (US); Tom Emery, Omaha, NE (US); Douglas E. Johnson, Omaha, NE (US); Nabil Abu EI Ata, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO

(21) Appl. No.: 10/382,093

(22) Filed: Mar. 4, 2003

Related U.S. Application Data
(60) Provisional application No. 60/362,222, filed on Mar. 4, 2002.

(51) Int. Cl. G06F 17/60

(52) U.S. Cl. 705/39

(57) ABSTRACT

A system for processing credit card related transactions is provided. According to one aspect of the system, the system adopts a three-layered architecture having an access layer, a system service layer and a base platform layer. The system further includes a number of core processing applications and their associated data. The core processing applications and their associated data are accessible through the access layer. The base platform layer includes a number of different technology platforms and their associated hardware. The system services layer provides a number of system services which are used to support the system and is used to insulate the access layer from the base platform layer. The access layer is used to provide access to the core processing applications and their associated data. The access layer offers a number of services to allow the core processing applications and their associated data to be accessed in a transparent manner. Examples of the services offered by the access layer include right-time management services, application services, presentation services, insulation services and data services. A number of business applications can be connected to the access layer to access the core processing applications and their associated data.

### CROSS-REFERENCES TO RELATED APPLICATION

The present application claims the benefit of priority under 35 U.S.C. § 119 from U.S. Provisional Patent Application Serial No. 60/362,222, entitled “METHOD AND SYSTEM FOR PROCESSING CREDIT CARD RELATED TRANSACTIONS,” filed on Mar. 4, 2002, the disclosure of which is hereby incorporated by reference in its entirety for all purposes.

### BACKGROUND OF THE INVENTION

The present invention generally relates to transactions involving credit cards. More specifically, the present invention relates to a computerized method and system for processing credit card related transactions.

The birth of a credit card generally begins with an applicant supplying information to complete a credit card application and apply for a credit account with an issuer or issuing bank. The issuer is usually a bank that issues the credit card and extends credit to the cardholder through the credit account linked to the credit card. Typically, the process of supplying the necessary information can be done electronically or by paper. The credit card application is then processed, and if approval criteria are met, a credit card is issued to the applicant who now becomes a cardholder. The process of issuing a credit card involves a number of steps including, for example, coding the credit card with cardholder data on the magnetic stripe and embossing the cardholder's name, account number and expiration date on the credit card.

When the credit card is first received by the cardholder, the cardholder needs to activate the credit card. Activation of the credit card is generally done by requiring the cardholder to call the issuer from his/her home phone. Once the credit card is activated, the cardholder may then use the credit card to make purchases or conduct transactions.

A typical credit card transaction involves a number of parties. In addition to the cardholder and the issuer, the parties involved in a credit card transaction include a merchant, an acquirer and a credit card association such as Visa or Mastercard. The acquirer is a business entity, e.g., a commercial bank, that has a business relationship with the merchant and handles credit card transactions from that merchant.

A typical credit card transaction involves the following steps. First, the merchant calculates the amount of the transaction or purchase and seeks payment from the cardholder. The cardholder then presents the merchant with his/her credit card. The merchant then runs the credit card through a point of sale terminal. The point of sale terminal captures credit card and sales information and sends such information together with an authorization request to the acquirer. The acquirer, in turn, processes the information received from the point of sale terminal and forwards any relevant information and the authorization request to the issuer. The issuer processes the relevant information and the authorization request to determine whether the transaction should be authorized. The issuer then sends an approval or denial code back to the acquirer. The acquirer relays the approval or denial code to the point of sale terminal for use by the merchant. If the transaction is authorized, the cardholder is allowed to consummate the transaction with the merchant. Typically, at a later time, the accounts maintained by the issuer and the acquirer are settled and reconciled. The end result is that the issuer transfers the transaction amount minus a fee to the acquirer. The acquirer then deducts a fee from the amount received from the issuer. The remaining amount is then transferred by the acquirer to the merchant's account. The foregoing is merely a general description of a typical credit card transaction. Variations and additional process(es) may be involved. It should also be understood that while certain parties, such as the issuer and the acquirer, are described above as performing certain functions, in typical situations, most or all of the functions to be performed by these parties may be performed on their behalf by third parties.

As described above, a typical credit card transaction involves many different processes. Considering the number of credit card transactions which occur every day, a tremendous amount of processing needs to be conducted. Many of these processes are still being handled by computer systems which continue to utilize batch processing. FIG. 1 illustrates a general batch processing system. Information collected from online transactions 10 and batch files 12 are combined into a transaction file 14. The transaction file 14 is stored usually in the form of magnetic tapes. The batch processing system 16 then processes the transaction file 14 and generates various output files 18 which are then passed onto backend systems 20 for further processing.

In many applications, batch processing has proved to be inefficient and lacking in ability to provide real-time response or access. For example, in batch processing, all the transactions to be processed are first collected and then processed at a designated time. Thus, the processing load of a computer system which does batch processing is unevenly distributed with the heaviest processing load occurring when batch processing is being executed. This results in inefficient use of system resources. Furthermore, since transactions are not processed in real-time, activities posted to a credit account are generally not reflected until the transaction batch is run.

Hence, it would be desirable to provide a computerized method and system which is capable of processing credit card related transactions in a more efficient manner.

### SUMMARY OF THE INVENTION

A computerized system for processing credit card related transactions is provided. According to one exemplary embodiment of the computerized system, the computerized system adopts a multi-layered architecture having a number of technology related layers and business related layers. The technology related layers include an access layer, a system services layer and a base platform layer. The business related layers include a number of business applications and core processing applications. The access layer provides insulation between business applications, core processing applications, their associated data and the implementation-specific details behind these applications. The system services layer includes system software products that provide processing functionality within the computerized system. The base platform layer includes a number of different technology platforms including hardware and system software.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 is a simplified diagram illustrating a general batch processing system;

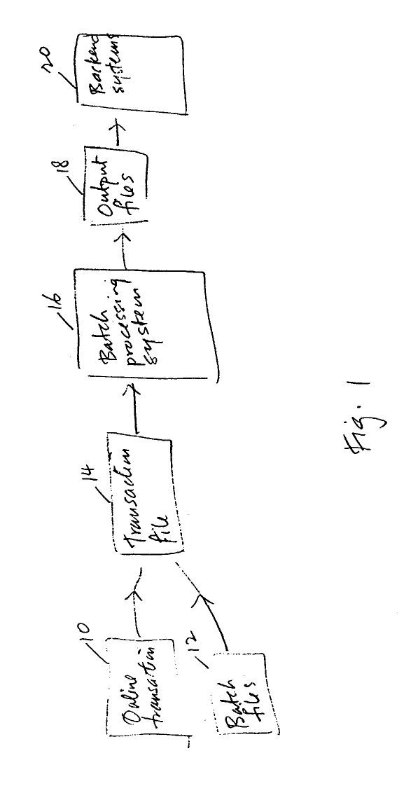

FIG. 2 is a simplified diagram illustrating an exemplary perspective of the system architecture of a computerized system which is designed to handle credit card related transactions in accordance with the present invention;

FIG. 3 is a simplified diagram illustrating another exemplary perspective of the system architecture of the computerized system which is designed to handle credit card related transactions in accordance with the present invention;

FIG. 4 is a simplified diagram illustrating an exemplary top perspective of the system architecture shown in FIG. 3 in accordance with the present invention;

FIG. 5 is a simplified diagram illustrating a partial exemplary logical view of the system architecture shown in FIG. 3 in accordance with the present invention; and

FIG. 6 is a simplified diagram illustrating an exemplary physical topology of the system architecture shown in FIG. 3 in accordance with the present invention.

### DETAILED DESCRIPTION OF THE INVENTION

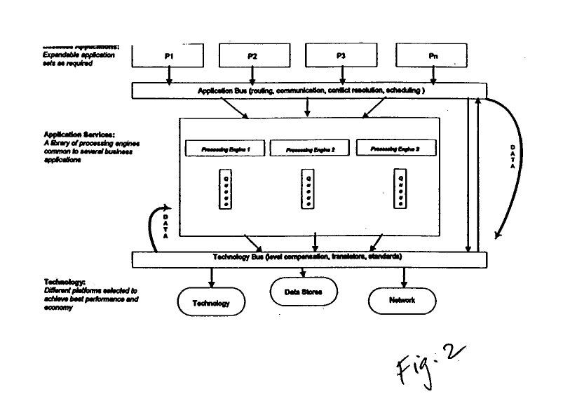

The present invention in the form of one or more exemplary embodiments will now be described. FIG. 2 is a simplified diagram illustrating an exemplary perspective of the system architecture of a computerized system or infrastructure which is designed to handle credit card related transactions in accordance with the present invention. Referring to FIG. 2, the system architecture adopts a layered approach. There is a total of five (5) layers, namely, the business applications layer, the application bus layer, the application services layer, the technology bus layer, and the technology platform layer.

The business applications layer includes a number of expandable business applications that are used to provide various business services. The business context of processing, i.e., the structure/flow/meaning of the requested work, when viewed by a business user, is controlled by these services, including but not limited to, input acquisition, segmentation of work units, invocation of subservient processes, and output presentation. The business applications layer also contains common application services that provide needed common application functionality to the business applications.

The application bus layer provides the necessary communication protocols and configuration information to allow any application to invoke any needed service, regardless of the physical location of that requested service. For example, there may be requests from the business application layer to services within the application services layer.

The application services layer includes a number of modularized service engines and common application services. These engines/services are used in varying orders by business applications to obtain the desired business results. They may be invoked from the business application layer or from within the application services layer, depending on the need of the specific business function to be accomplished.

The technology bus layer provides access to the technology platform layer. This includes insulating business applications and application engines from the physical hardware, the network, and the physical data storage mechanisms.

The technology platform layer includes a number of different technology platforms (and their associated physical hardware) which are selected to achieve optimal performance and economy.

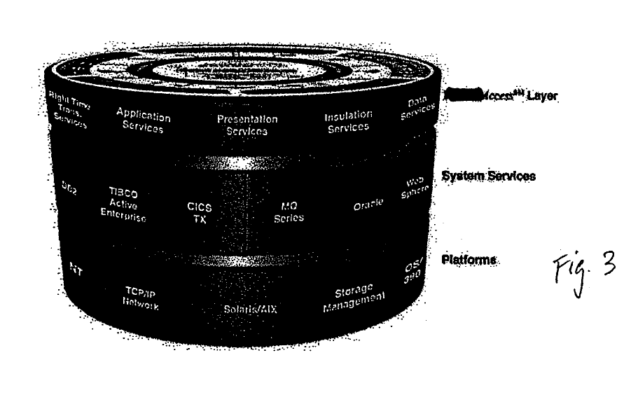

FIG. 3 is a simplified diagram illustrating another exemplary perspective of the system architecture of the computerized infrastructure which is designed to handle credit card related transactions in accordance with the present invention. Referring to FIG. 3, the system architecture adopts the same layered approach. From this exemplary perspective, three (3) of the layers are shown, namely, the base platform layer, the system services layer and the access layer. Each of these three (3) layers will be further described below.

Referring to FIG. 3, the base platform layer includes a number of different technology platforms and their associated hardware including computers, operating systems and networks. In an exemplary embodiment, the base platform layer includes, for example, the OS/390 platform, the Unix platform, the Windows NT or 2000 platform, TCP/IP networks and storage management. These various platforms are chosen so as to optimize different aspects and performance of the computerized infrastructure. For instance, the Unix platform may be used to support web and Java applications. A person of ordinary skill in the art will know how to select and implement the various platforms to be included in the base platform layer. Running on the base platform layer is a set of system services located in the system services layer.

As mentioned above, there is a set of system services located in the system services layer. Some of these system services are provided by readily available commercial software, while others may be internally or custom developed. These system services are deployed across all platforms. Although these system services are thought of as “platform independent”, platform specific deployments may be needed in some situations to provide some of these system services across all platforms. These system services are made available to application developers in a standardized manner by the access layer regardless of the platform in the base platform layer hosting the applications. Some of the system services are available from off-the-shelf or stand-alone software products offered by software vendors, including, for example, CICS, Websphere, TIBCO Active Enterprise, MQ Series, Oracle, Solaris and DB2. The system services are designed to perform a number of functions. The system services include, for example, asynchronous messaging and queuing, synchronous messaging, publish/subscribe messaging, data management, transaction management, web server service, application server service, translation/transformation services, and business process flow control, each of which will be described further below.

The asynchronous messaging and queuing service provides asynchronous messaging between applications or system services through shared message queues. The synchronous messaging service provides communication between two applications where the sender waits for a reply from the receiver before continuing. Local or remote procedure calls are used in connection with this service. The publish/subscribe messaging service handles messaging between a publisher (initiator) of an event and one or more subscriber (consumers) of the event. The data management service manages the data stores used by the applications and provides data access, recovery, integrity, performance management and stored procedures. The transaction management service manages units of work across resource managers and provides transaction scheduling, initiation, rollback and recovery for failed transactions. The web server service manages the web interface and presentation for transactions. The application server service provides the server environment for back-end application functions such as JSPs (Java Server Pages) and EJBs (Enterprise Java Beans). The translation/transformation service provides data transformation and adaptation between applications, such as ASCII/EBCDIC conversion, data type conversions (packed decimal to display) and message reformatting. The business process flow control service provides workflow management amongst cooperating applications or modules to allow flexible configuration of business applications without programming.

The access layer provides insulation between the applications and the system services and/or the base platforms. The access layers allows business applications, application services, and system services to communicate with each other. To provide this access, the access layer offers a set of services and programming interfaces. These interfaces provide to external applications (i.e., applications which are not part of the core processing applications) a standardized way of utilizing the core processing applications within the computerized infrastructure. As will be further described below, the coupling of the external applications with the core processing applications may be viewed as providing “value added” services.

The set of services offered by the access layer includes right-time transaction management services, application services, presentation services, insulation services and data services, each of which will be further described below.

The right-time transaction management services are provided by the access layer to manage the execution of each request for access to all services within the system. The right-time transaction management services also ensure that the core processing applications and their associated data are continuously available for access upon demand from clients of the computerized system. The right-time transaction management services further ensure that the capabilities of the operating environment of the computerized infrastructure are leveraged to maximize resource availability, reliability and scalability. The right-time transaction management services are made up of a number of services including, for example, continuous availability management, workload management, unit-of-work management, fault management, scheduling/calendar management and logging/tracing services.

Continuous availability management service is used to ensure that core processing applications which are mission critical are continuously available. A failed application is restored to its executing state using one of two methods. The failed application can be restored to its pre-failure state or a new instance of the failed application can be invoked. Fault management, as will be described further below, initiates or invokes the continuous availability management service when an application has failed.

Workload management service is used to optimize resource utilization within the computerized infrastructure. Redundant or idle resources are leveraged. If any service or process on a particular device is reaching its performance threshold, workload management service ensures that subsequent process(es) will be invoked on devices having the capacity to perform the function(s).

The unit-of-work management service provides the capability to control a series of process steps as a single business context. All process steps within the single business context are monitored. If any part of the series of process steps fails or cannot be undertaken, the entire business context is returned to its starting state. Check-point, commit and rollback features are included within the unit-of-work management service.

Fault management service is responsible for detecting faults within the computerized infrastructure and ensuring that, at least, critical applications are kept running without significant interruption. When fault management service detects a fault or some other problem with an application, the fault management service invokes the continuous availability management service to restore operation.

Scheduling/calendar management service is used to schedule and/or dispatch modules or application code to run in the appropriate execution environment at the appropriate time to ensure that the applications are executed correctly.

Logging/tracing service is used to keep track of events that occur during the execution of an application or a service. For example, events, such as a fault, are logged so that information is available to allow appropriate remedial measures to be taken. Under this service, tracing, auditing and alerting at the system component level are provided.

Application services are provided as part of the access layer. Application services collectively act as a mechanism to allow one application code to invoke or request work by another application code. The collective goal of the application services is to optimize application code usage so that such code can be reused and/or shared by different applications and/or services across the computerized infrastructure. The application services deal directly with access to the core processing applications and all common application services. The application services include, for example, a number of features such as common components, engines, security/authorization, auditing/journaling, and time services, each of which will be described further below.

With respect to common components, these are components which are commonly used and/or shared by different applications and/or services across the computerized infrastructure. By having these common components, redundant code can be eliminated. These common components are accessed via an internal, standardized application program interface.

With respect to engines, these are collectively a specific type of common component. These engines are written for high performance and reused by many different applications. For example, one engine is an application that does credit scoring (i.e., assessing an individual's credit worthiness). Engines are also accessed via an internal, standardized application program interface.

With respect to security/authorization, this is provided and implemented across the computerized infrastructure. Providing the security/authorization function as part of the application services ensures that such function is implemented consistently and uniformly across the computerized infrastructure. The security/authorization function is used to authorize access to protected applications and other services or system resources. The security/authorization function is issued implicitly within the access layer whenever any request is made to invoke another service. Additionally, this function may be invoked explicitly by applications to verify which features are accessible to an authenticated client.

The auditing/journaling function provides applications with reliable historical logs and data regarding events that occur during the execution of an application or service. The auditing/journaling function is used in cooperation with the logging/tracing service to ensure that any event that occurs during the execution of an application or services is properly recorded.

The time service is used to provide common representation of date and time across all applications within the computerized infrastructure. The common representation of date and time is important where multiple time zones are involved. The time service ensures that there are standards for time formatting, synchronization and conversions.

Presentation services are another type of services provided by the access layer. Presentation services allow the same core processing application to be presented to various clients in different formats or interface methods. That is, presentation services function as a translator point between the native formats required to drive the core processing applications and data and the formats required for the interface of the requestor's device. The interface can be a human or a machine interface. Presentation services include, for example, a number of features such as interface gateways, security/cryptography, common user interface facilities, data representation and security/authentication, each of which will be described further below.

The interface gateways are used to translate external presentation protocols to and from internal protocols. The interface gateways are responsible for converting non-native transport protocols and representations to native ones. The use of the interface gateways allows the core processing applications to be presentation neutral, i.e., the core processing applications are capable of being accessed via various client methods. The interface gateways include, for example, WAP, tape, file transfer, HTTP and asynchronous dialup.

The security/cryptography function is used to standardize the way information is exchanged between the computerized infrastructure and a client and to protect such information from unauthorized use. This protection is provided by the security/cryptography function through its use of encryption and decryption. Encryption and decryption algorithms which are well-known in the industry are used to implement this function.

Common user interface facilities are provided to give a common look and feel across applications available within the computerized infrastructure. Common user interface facilities include, for example, HTML and graphical user interface.

The security/authentication function is used to provide client authentication and validation when a client signs onto the computerized infrastructure. As will be described further below, a client is able to access the computerized infrastructure to have various services performed. This function ensures that the client logging onto the computerized infrastructure is a valid client.

Insulation services are provided by the access layer. Insulation services are used to facilitate communications amongst applications and/or services. These services are provided so that an application or service invoking another application or service does not need to know where the other application or service is located within the computerized infrastructure. Conversely, these services allow an application or service to communicate with another without having to deal with the complexity of the underlying, heterogeneous operating platforms, communication protocols or different public and private message formats. Insulation services include, for example, a number of features such as distribution service, connection management, translation/brokering service, registration/directory, event management, and flow control, each of which will be further described below.

The distribution service provides the capability for an invoking application or service to invoke another application or service without the need for the invoking application or service to know the location, path or state of the invoked application or service. Furthermore, the distribution service ensures that the respective workloads of the applications and services within the computerized infrastructure are distributed evenly so as to optimize system performance. The distribution service provides a common application programming interface by which all requests to invoke a service are made. The distribution service uses the information in the registration/directory (to be further described below) to determine how and where to route each request. In collaboration with the connection management service (to be further described below) and all applicable system layer components, each request/response is routed to the proper service.

The connection management service provides access or transport to registered services. All application components that can be invoked by more than one requestor are written as reusable services. These services are “registered” with the registration/directory service (to be further described below). The information in the registration/directory service is used by connection management service to properly route each request. The connection management service allows an application or service to interface or interact with another application or service without having to know the details about the underlying or collaborating components of the other application or service.

The translation/brokering service offers various capabilities including, for example, conversion from ASCII to EBCDIC, translation from dollars to pounds, transforming from an external representation to an internal one, etc.

The registration/directory service is a directory feature that is used to manage elements relating to the state or nature of an application or a service that is available within the computerized infrastructure. The elements being managed include, for example, state, location, path, name, version etc.

Event management service is provided to monitor and signal the occurrence of a defined business event. This service includes definition and prioritization of the events, managing queues of events, and initiating error or exception handling.

Flow control service is provided to execute at the business entity level a series of pre-existing business process steps that are registered as services. Flow control is provided at the business entity level to allow each client to distinguish its business flows from those of other clients, and may be specific within sub-groupings of a given client. This service includes features such as conditional logic execution, effective dating and shared server/client control.

Data services are also provided by the access layer. Data services provide real-time data update and retrieval capabilities into and out of data storage elements within the computerized infrastructure. Data services deal directly with access to the data stored in the data stores within the computerized infrastructure. Data services include, for example, a number of features such as enterprise data stores, data repository, data access layer, and data access facility, each of which will be described further below.

Enterprise data stores are direct access data stores that are used to store the business data upon which the application operate, such as data relating to a customer or data relating to an account. The enterprise data stores are accessed via the data access layer, to be further described below, from application systems. The enterprise data stores are used for different purposes. Some of the enterprise data stores support production and operational reporting needs and others act as a staging area to handle online analytical processing decision-support needs. The data access facility, to be described further below, primarily uses the staging area to retrieve decision-support data.

Data repository is used to store the context behind the components of the system. Context refers to the information that describes each of the components. Data store components and code components are described in the data repository. The data repository helps promote system-wide reuse of components within the computerized infrastructure. Examples of reusable components are logical data models, physical database designs, data element definitions and valid values, data transformations and mapping routines, business rules and parameters, etc. An associated directory service is provided to allow users to retrieve information from the data repository.

The data access layer provides a number of services such as data extraction, transformation and reformatting in response to data requests. Data extraction is done to retrieve data from the appropriate enterprise data stores. Transformation and reformatting are performed to ensure that the retrieved data is formatted appropriately for the requesting application or service. Furthermore, the data access layer allows program code for input/output (I/O) to be separated from application logic. This separation facilitates reuse of I/O routines and provides the opportunity to manage I/O code independently of application logic.

The data access facility is a workbench environment that provides analytical data access, delivery and reporting services to internal and external clients within the computerized infrastructure. The data access facility also produces standard reports and pre-built analyses based on client need. Standard and other reporting needs are satisfied from data stored within the enterprise data stores. As mentioned above, the data access facility utilizes online analytical processing and other tools to meet analytical and decision-support requirements and basic Extract, Transform, Load (ETL) tools to generate extracts that meet client-specific formatting needs.

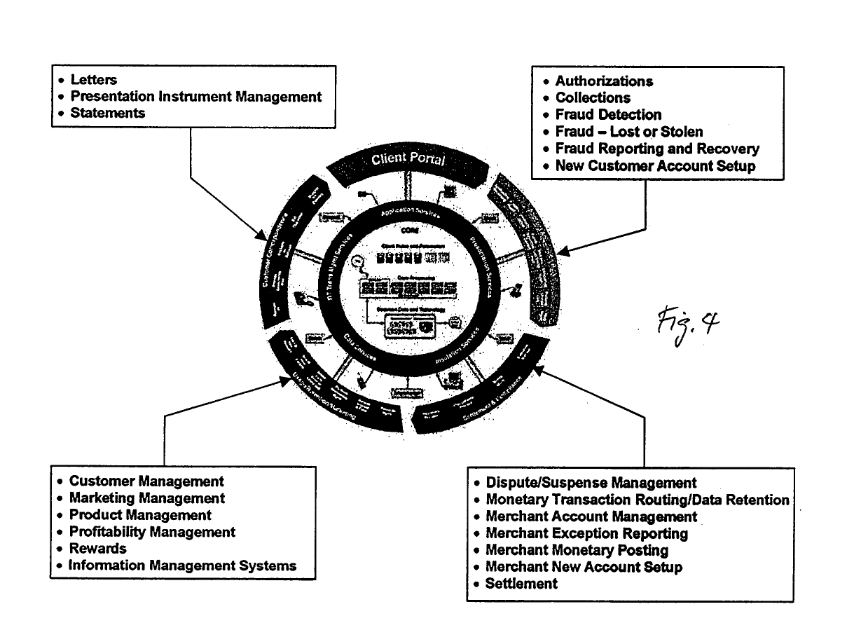

FIG. 4 is a simplified diagram illustrating an exemplary top perspective of the system architecture. FIG. 4 further illustrates the application layer of the system architecture. Referring to FIG. 4, the business application layer is depicted as a series of outer ring-segments. These segments attach to the access layer which encircles the application services layer. Several parts of the application services layer are depicted, including a number of core processing applications and their associated rules and parameters and various data stores. Each client, for example, may have its specific rules and parameters and data stored within the computerized infrastructure. The location where the core processing applications (or application services), the associated rules and parameters and the data stores are situated is conceptually referred to as the “core”. The core processing applications are used by clients of the computerized infrastructure to execute various related processes or transactions. During its execution, a core processing application may access rules and parameters and data which are specific to the client requesting the service provided by the core processing application. As previously described, the access layer provides a number of services which allow these core processing applications to be accessed by the clients. It should be understood that these core processing applications are applications which are commonly shared or used by business applications that exist in the business application layer. It will be appreciated by those of ordinary skill in the art that these core processing applications will vary depending on the design of the computerized infrastructure. For example, in the credit card processing context, these core processing applications may include an application to post a monetary transaction and an application to update a credit account or customer, etc.

The computerized infrastructure as described above supports three types of engagement modes or models, namely, the batch engagement model, the interactive engagement model and the event engagement model, each of which will be described further below. These engagement models are used to describe various types of interactions which may be incurred with the computerized infrastructure.

The batch engagement model describes the process of collecting a series of transactions and baseline data and applying a sequence of processes against such transactions and data in a consecutive sequential manner. Typically, this sequence of processes is initiated at a pre-defined point in time and is completed within a predetermined period of time. At the completion of a batch processing sequence, the results are represented as a set of data which is a static point-in-time entity.

The interactive engagement model describes the process of an entity (e.g., user, application, service, system process, etc.) making a request of one or more other entities and expecting some form of a reply. This model is useful in cases where completion of the business process requires interaction. The request can be for access to data only, access to an application, access to a service, or a combination of the above. The basic interactive engagement model has some varying styles describing whether the initiating entity waits until the reply is received (“synchronous”) or continues on expecting the reply at a later but unspecified time (“asynchronous”). Another style of this model describes the initiator and receiver interaction occurring over several request/reply sequences and the interaction not being considered complete and committed until all sequences are successfully completed (“stateful” process); alternatively, each request/reply sequence can be considered an independent interaction (“stateless” process). The application of the appropriate combination of styles of the interactive engagement model depends on what the business process requires.

The event engagement model describes a process in which an entity wishes to notify another entity about the occurrence of a pre-defined action being taken or a condition or state occurring. The event engagement model is asynchronous by nature since the notifying entity is not dependent on the outcome of the notification as a prerequisite to continue processing. Similar to the interactive engagement model, the event engagement model has various styles. The styles vary according to characteristics such as: number of entities to be notified (one, few, many), predefined or self-identified recipients (point-to-point v. publish/subscribe), degree of assurance required that the event arrives at the destination (fire-and-forget v. assured delivery), and sensitivity of recipient to time delay of arrival (zero latency).

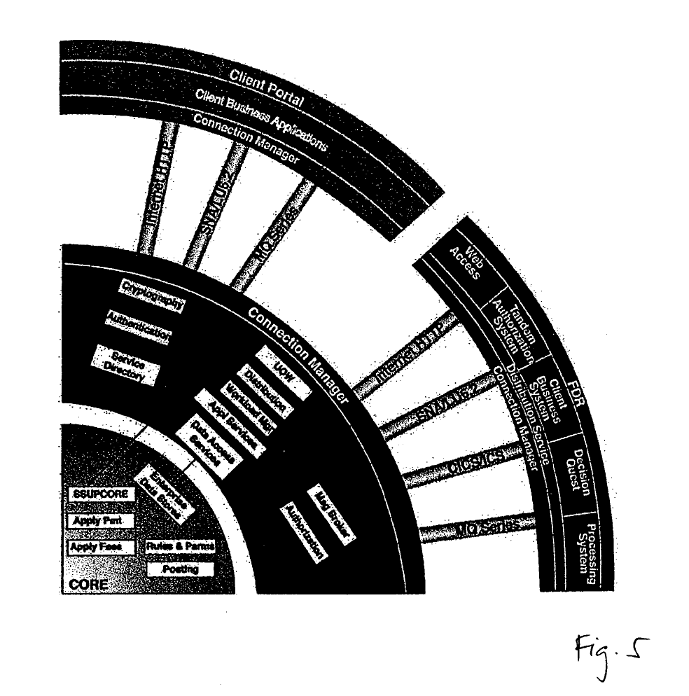

FIG. 5 illustrates a partial exemplary logical view of the system architecture shown in FIG. 3 and FIG. 4. As shown in FIG. 5, the services offered by the access layer relate to and interact with one another to enable access to the core processing applications. In an exemplary embodiment, underlying these services is a set of control information established at the initiation of each session and retained until the session is terminated. As mentioned above, the insulation services provide the connection management service to facilitate access to the core processing applications by an external application. The control information is used at each service request interaction with the access layer and contains a broad spectrum of security, performance/utilization, tracing, and transactional context data. The control information spans platforms and is accessible to all services offered by the access layer.

As mentioned above, two services, the distribution service and connection management service, offered under the insulation services are the principal interface points to the access layer from a developer's perspective. The connection management service is invoked to establish the interface between the core processing application and a client's business applications or systems. The distribution service establishes the ability to locate and invoke a service wherever it may exist within the computerized infrastructure. Policies are developed using a rules context to control the operation of the distribution service and the invocation of other services. The policies are externally defined sets of attributes detailing how a particular service request is to engage the various services offered by the access layer. In this way, the distribution service, in conjunction with the policies, determine how the remaining services making up the access layer are utilized to meet the needs of a particular engagement model and interaction style with the core processing applications.

In an exemplary embodiment, a group of services categorized as foundation class services is responsible for allowing access to the core processing applications to be achieved from an external application or system. This group of services includes the connection management service, the unit-of-work management service, the distribution service, the workload management service, the data access service and the data access facility.

Another group of services categorized as support class services is responsible for supporting the foundation class services. This group of services is invoked by the foundation class services when called for by the policies applied for the specific instance of the session type and message type being processed. This group of services includes security/cryptography, security/authentication, message broker, fault management, logging and tracing, audit/journal, time service, parameter control and registration/directory.

A third group of services categorized as process class services is responsible for facilitating the capability to enable several styles of engagement models to be implemented. This third group of services includes common user interface, schedule/calendar, event management and flow control.

Services within each group of services interact with other services from within the same group as well as other services from other groups. For example, the distribution service and the workload management service together enable other services offered by the access layer and core processing applications to be executed across a variety of heterogeneous computing platforms. Platform capability can be added and managed to support availability and scalability without modifying other services or application components. The distribution service and message broker service isolate applications from changes in internal components and other services. Message broker service performs message conversion without the need for application compensation code. The distribution service is designed to access a specific application module based on the name contained in the registry/directory. The unit-of-work management service provides reliability and integrity in terms of transactional-based access to core processing applications and enterprise data stores. These services support a form of versioning that is able to isolate components and permit upgrades of parts of the computerized infrastructure without affecting others.

It should be understood that the various services provided by the access layer can be implemented using software, hardware, or a combination of both, in a modular or integrated manner. For example, a service may be implemented in the form of control logic within a module using software. Based on the disclosure provided herein, a person of ordinary skill in the art will know of other ways and/or methods to implement and apply the present invention.

The various services provided by the access layer are capable of interacting logically with each other. For example, referring to FIG. 5, the connection management service receives activity (input) from any spoke, after the activity has been authenticated via the authentication service. The connection management service determines what service is required to service the activity and invokes the distribution service to locate the requisite service. The distribution service uses the workload management service to determine which instance of a service should receive the request (in order to balance the work). The request is passed through to the authorization service to ensure the source/requestor is authorized to access the requested service, prior to distribution routing the request to the destination service that is to service the request. It should be understood that the various services offered by the access layer may interact with each other in different manners. Regardless of how these various services interact, the access layer serves to facilitate access to the core processing applications by external applications, such as a set of business applications, to be further described below.

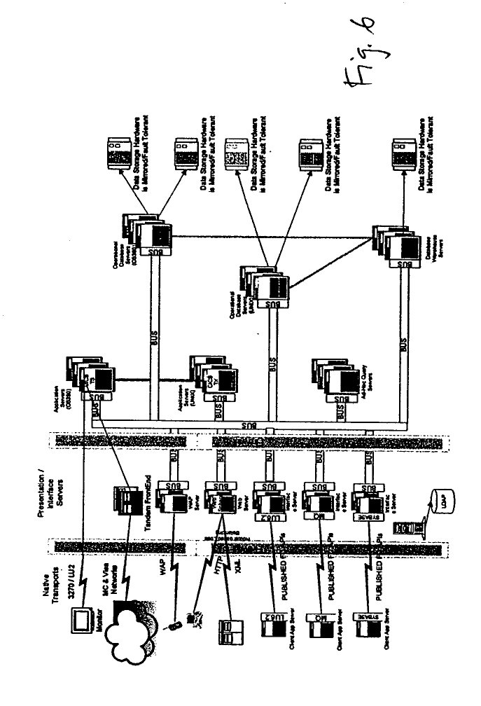

FIG. 6 illustrates an exemplary physical topology of the computerized infrastructure as described in FIG. 3. It should be understood that other physical implementations of the computerized infrastructure are possible and that a person of ordinary skill in the art will know of other ways and/or methods to implement the computerized infrastructure as described herein. Referring to FIG. 6, the computerized infrastructure includes a number of presentation or interface servers. These interface servers provide interface presentation exchange with the users. Generally, these interface servers are organized into farms or clusters, where failure of a single interface server does not affect the other interface servers. These interface servers allow for access by a private network, the Internet, an intranet, an extranet and other types of computer network. In addition to providing interface presentation exchange, these interface servers also provide several other functions including authentication, authorization and transcoding. Strong authentication is used to confirm access to the computer infrastructure and roles are checked to ensure the authenticated client is authorized to utilize the requested service.

The computerized infrastructure also includes two firewalls. The first firewall is located between the interface servers and the client servers. The first firewall is made up of three layers including a filter routing layer, a hardware and software firewall layer and a distribution routing layer. The filter routing layer is part of a perimeter security layer. The primary purpose of the filter routing layer is to selectively choose, based on a set of defined parameters, which client servers and their incoming packets are permitted to proceed further into the computerized infrastructure. The packets which have been permission to proceed are then forwarded to the appropriate network address.

The firewall layer is also part of the perimeter security layer and marks the out-edge of a demarcation zone (DMZ). The firewall layer subject incoming packets to further examination before they are allowed into the DMZ.

The distribution routing layer, also known as the load-balancing layer, exists inside the secured perimeter layer and determines where incoming traffic is to be sent. The primary function of the distribution routing layer is to load balance traffic across the interface servers to optimize use of system resources.

The second firewall is located between the interface servers and the business application servers. The second firewall and the first firewall together form the demarcation zone. The second firewall ensures that only authenticated sources or client servers are allowed access to the core processing applications.

The computerized infrastructure further includes a number of business application servers. These business application servers can be categorized into two general groups. The first group includes customizations tailored for clients, and consequently, has a high rate of change. This first group tends to be used more in a synchronous fashion. The second group is generally used to process large volume of data with low latency. Consequently, this second group tends to be less customized for clients and is managed for high performance usage with a lower rate of change. This second group tends to be used more in an asynchronous fashion.

The computerized infrastructure also includes a bus structure that allows a service to be accessed wherever such service might reside. One of the functions of the bus structure is to provide distribution service which, amongst other things, determines where a message requesting a specific service is to be sent. The distribution service determines where a target service resides, load-balances traffic across the instances of that service, and routes traffic to the appropriate destination. Access to a service is controlled through a security manager of the bus structure.

The bus structure provides much of the application middleware that is used to allow communications between the core processing applications and services offered by the access layer. The bus structure also performs task control (unit-of-work management service) and workload balancing (workload management service) associated with an application. The bus structure also provides an interface to the underlying technologies which are used to implement the computerized infrastructure thereby isolating the underlying technologies from the core processing applications and the services offered by the access layer.

The computerized infrastructure includes a number of core processing application servers. These core processing application servers are used to house and execute the core processing applications. In order to enhance performance, data to be processed and/or used by the core processing applications is stored close to the core processing application servers to allow faster access.

A number of data servers are included within the computerized infrastructure. These data servers are used to implement the data access service. As mentioned above, the data access service provides for abstraction of the physical location of the data, i.e., the data access service insulates the business and core processing applications from the physical technology which is used to implement the data servers. Hence, an application requesting data does not need to know where the data physically resides. Thus, the data can be physically moved from one location to another without affecting the applications that might need access to such data. There are two types of data servers, namely, operational database servers and data warehouse servers. Operational database servers are used to house data that are needed for processing purposes by the core processing applications. These operational database servers employ a variety of industry-standard database technologies such as relational databases and traditional file structures (including stream and record-oriented sequential, relative-record, and indexed). Data warehouse servers are used to store data that is used for analytical purposes such as ad hoc query and online analytical purposes.

FIG. 4 further illustrates an exemplary set of business applications which is supported by the computerized infrastructure. As shown in FIG. 4, the set of business applications can be divided into a number of categories. These applications are available to a user or client of the computerized infrastructure. It should be understood that these business applications are shown herein for illustrative purposes only. It will be appreciated by a person of ordinary skill in the art that the types of business applications that may be implemented and used in connection with the computerized infrastructure may vary depending on the context within which the computerized infrastructure is used.

The first category of business applications that are available to a user relates to account acquisition and risk. Applications within this category handle, for example, authorizations, collections, fraud detection, fraud prevention, fraud reporting and recovery and new customer account setup, each of which will be further described below.

The authorizations application provides the ability for a merchant to request an authorization to incur activity on a credit card account. The application renders a decision on authorization according to certain predetermined fraud and credit rules which are stored within the computerized infrastructure. The decision on authorization may include, for example, authorized, declined or referred. The decision is relayed to the merchant by the authorizations application. Furthermore, the authorizations application also maintains the inventory of the matched and outstanding authorizations.

The collections application provides the ability for a client to control the flow of delinquent and/or overlimit account data to a collection system. The collection system can be located external to the computerized infrastructure. The collection system may then take appropriate actions in response to the delinquent and/or overlimit account data.

The fraud detection application allows a client to detect possible fraud in connection with activities incurred on a credit card account. The fraud detection application includes rules and/or scoring interfaces into other applications. These other applications may accept information from the fraud detection application and take further appropriate actions.

The fraud prevention application provides the ability to block account activities relating to presentation instruments which have been reported as lost or stolen or are suspected as potentially fraudulent. Furthermore, the fraud prevention application may invoke creation of a fraud account to manage fraud dollars.

The fraud reporting and recovery application provides the ability to manage the investigation, recovery and reporting of fraud in connection with a credit card account. The fraud reporting and recovery application further ensures that any client or regulatory reporting requirements are complied with.

The customer account setup application provides the ability to evaluate an applicant's application for credit line and, if the application is approved, establish a credit card account and initiate other processes in connection with establishing the credit card account such as issuing the presentation instrument.

The second category of business applications that are available to a user relates to settlement and industry compliance. Applications within this category handle, for example, dispute/suspense management, monetary transaction routing/data retention, merchant account management, merchant exception reporting, merchant monetary posting, merchant new account setup, and settlement, each of which will be further described below.

The dispute/suspense management application provides the capability to investigate and resolve claims and disputes made by cardholders about their accounts. For example, the dispute/suspense management application reclassifies a transaction or balance from a standard balance into a suspended state for further investigation.

The monetary transaction routing/data retention application provides the capability to capture information from an applicant's credit application and forward such information to an issuer's clearinghouse for fraud check and receive a response. Furthermore, the batch submission of basic monetary transactions can also be initiated.

The merchant account management application provides the capability to monitor and maintain account portfolios of merchants.

The merchant exception reporting application provides the capability to supply acceptance instruments or applets to defined merchants. In addition, the application enables the process of evaluating a merchant account for closure, recovering merchant instruments as necessary, and updating all interested parties of new status relating to a merchant account.

The merchant monetary posting application provides the capability to receive and process monetary transactions. The monetary transactions are posted to the merchants' accounts. The processing of monetary transaction includes, for example, processing credits, debits, payments, fees, interest and adjustments.

The merchant new account setup application provides the capability to set up a new account for a merchant. The application enables the process of taking an application from a prospective merchant to completing the application to either opening an account or notifying the merchant of the reason for decline.

The settlement application provides the capability to collect and maintain the net position of a client, generate general ledger feeds, collect and maintain net positions for inter-country settlement and perform transfers of funds.

The third category of business applications which are available to a user relates to usage, retention and marketing. Applications within this category handle, for example, customer management, marketing management, product management, productivity management, reward management, and information management, each of which will be further described below.

The customer management application provides the capability to maintain customer demographic data and relationships between various entities, communication points, demographic data, and external to internal key relationships.

The marketing management application provides the capability to enable processes necessary to develop solicitations for new customer relationships, products and offers. This application further includes determining the business goals to be reached, gathering and qualifying the target market and developing requirements and materials, and tracking solicitation responses.

The product management application provides the capability to analyze, define, coordinate, test and implement a financial product. For example, rules relating to financial products may be defined and maintained and such rules may be invoked when financial products are processed.

The profitability management application provides the capability to allow clients to identify portfolio segments and analyze profitability of the clients' customers and/or their accounts.

The rewards management application provides the capability to maintain, qualify, and set up reward/award plans related to financial products and appropriate parties.

The information management application provides a data repository and meta-data repository for non-operational data. This application allows such repositories to be accessed and used for pre-defined and ad hoc client requests.

The fourth category of business applications which are available to a user relates to customer correspondence. Applications within this category handle, for example, letters management, presentation instrument management, and statements management, each of which will be further described below.

The letters management application provides the capability to forward written communications to potential or existing customers. The written communications can be related to, for example, account status and marketing solicitations or initiatives. The written communications include, for example, cardholder agreements, update or default information such as past due, overlimit and returned payment notification.

The presentation instrument management application provides the capability to maintain presentation instrument data. A variety of data is kept with respect to the presentation instrument, such as, the personal embossing name on the presentation instrument and status of the presentation instrument. Furthermore, the presentation instrument management application also provides the capability to renumber the presentation instrument and control the timing of reissue of the presentation instrument.

The statements management application provides the capability to generate customer statements for printing. Furthermore, this application also allows clients to design their own statements for their customers and provides flexibility for messaging, inserts, and other targeted communications.

It should be understood that the set of business applications which may access the access layer may interact with one another and that these applications may be implemented using software, hardware, or a combination of both, in a modular or integrated manner. Furthermore, it should also be understood that while the set of business applications as described above is classified based on functionality, these applications may be implemented as separate modules or in one single module depending on the design and system constraints or requirements. Based on the disclosure provided herein, a person of ordinary skill in the art will know of other ways and/or methods to implement these applications.

It should be understood that while an exemplary embodiment of the present invention as described herein is directed to a system which may be used in the credit card processing industry, it will be appreciated by a person of ordinary skill in the art that the present invention is applicable for use in other types of industries.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A computerized infrastructure for processing transactions, comprising:
a base platform layer having a plurality of technology platforms configured to support the computerized infrastructure;
an access layer configured to provide a plurality of access services;
a system services layer configured to provide a plurality of system services and insulate the access layer from the base platform layer;
a plurality of core processing applications that are accessible through the access layer using one or more of the plurality of access services; and
a plurality of business applications, wherein one or more of the plurality of business applications are configured to access one or more of the plurality of core processing applications via the access layer.

2. The computerized infrastructure according to claim 1 wherein the plurality of access services includes right-time management services, application services, presentation services; insulation services and data services.

3. The computerized infrastructure according to claim 2 wherein the right-time transaction management services are configured to manage execution of a request for access to one or more of the plurality of core processing applications.

4. The computerized infrastructure according to claim 3 wherein the right-time transaction management services further include a continuous availability management service, a workload management service, a unit-of-work management service, a fault management service, a scheduling/calendar management service and a logging/tracing service.

5. The computerized infrastructure according to claim 2 wherein the application services are configured to optimize use of application code across the computerized infrastructure.

6. The computerized infrastructure according to claim 5 wherein the application services further include a plurality of components and engines configured to be used or shared by the plurality of access services and the plurality of core processing applications, a security/authorization service configured to regulate access to the plurality of access services and the plurality of core processing applications, an auditing/journaling service configured to maintain historical logs and data relating to events which occur during execution of one of the plurality of access services or one of the plurality of core processing applications, and a time service configured to maintain common representation of time and date across the plurality of core processing applications.

7. The computerized infrastructure according to claim 2 wherein the presentation services are configured to allow a core processing application to be accessed and presented to a plurality of clients using different interface methods.

8. The computerized infrastructure according to claim 7 wherein the presentation services further include a plurality of interface gateways configured to provide access to the plurality of core processing applications, a security/cryptography service configured to secure information exchanged between the computerized infrastructure and a client, a plurality of common user interface facilities configured to provide a common look and feel across the plurality of core processing applications, and a security/authentication service configured to provide client authentication and validation when the client signs onto the computerized infrastructure.

9. The computerized infrastructure according to claim 2 wherein the insulation services are configured to facilitate communications amongst the plurality of access services and the plurality of core processing applications.

10. The computerized infrastructure according to claim 9 wherein the insulation service further include a distribution service configured to manage invocation of one of the plurality of core processing application, a connection management service configured to allow the plurality of core processing applications to interact with one another, a registration/directory service configured to manage execution of the plurality of core processing application, an event management service configured to monitor occurrence of a predetermined business event, and a flow control service configured to execute a series of steps within a business process.

11. The computerized infrastructure according to claim 2 wherein the data services are configured to provide real-time data update and retrieval into and out of data storage elements within the computerized infrastructure.

12. The computerized infrastructure according to claim 11 wherein the data services further include a plurality of data stores configured to store data, a data repository configured to store shared components within the computerized infrastructure, a data access layer configured to perform a plurality of data handling functions including data extraction, transformation and reformatting, and a data access facility configured to allow a user to access the data access layer.

13. The computerized infrastructure according to claim 1 wherein one or more of the plurality of core processing applications are capable of being invoked by a plurality of engagement modes.

14. The computerized infrastructure according to claim 13 wherein the plurality of engagement modes include a batch engagement mode, an interactive engagement mode and an event engagement mode.

15. A system for processing credit card related transactions, comprising:
an access layer having a plurality of access service modules including a right-time management service module, an application service module, a presentation service module, an insulation service module and a data service module;
a plurality of core processing applications that are accessible through the access layer using one or more of the plurality of access service modules; and
a plurality of business applications each configured to access one or more of the plurality of core processing applications via the access layer.

16. The system of claim 15 further comprising:
a base platform layer having a plurality of technology platforms configured to support the system; and
a system services layer configured to provide a plurality of system service modules and insulate the access layer from the base platform layer.

17. The system of claim 16 wherein the right-time management service module is configured to manage execution of a request for access to one or more of the plurality of core processing applications.

18. The system of claim 1 wherein the right-time management service module is further configured to provide a continuous availability management service, a workload management service, a unit-of-work management service, a fault management service, a scheduling/calendar management service and a logging/tracing service.

19. The system of claim 15 wherein the application service module is configured to optimize use of application code across the system.

20. The system of claim 19 wherein the application service module is further configured to include a plurality of components and engines configured to be used or shared by the plurality of access service modules and the plurality of core processing applications, and to provide a security/authorization service configured to regulate access to the plurality of access service modules and the plurality of core processing applications, an auditing/journaling service configured to maintain historical logs and data relating to events which occur during execution of one of the plurality of access service modules or one of the plurality of core processing applications, and a time service configured to maintain common representation of time and date across the plurality of core processing applications.

21. The system of claim 15 wherein the presentation service module is configured to allow a core processing application to be accessed and presented to a plurality of clients using different interface methods.

22. The system of claim 21 wherein the presentation service module is further configured to include a plurality of interface gateways configured to provide access to the plurality of core processing applications, a security/cryptography service configured to secure information exchanged between the system and a client, a plurality of common user interface facilities configured to provide a common look and feel across the plurality of core processing applications, and to provide a security/authentication service configured to provide client authentication and validation when the client signs onto the system.

23. The system of claim 15 wherein the insulation service module is configured to facilitate communications amongst the plurality of access service modules and the plurality of core processing applications.

24. The system of claim 25 wherein the insulation service module is further configured to provide a distribution service configured to manage invocation of one of the plurality of core processing application, a connection management service configured to allow the plurality of core processing applications to interact with one another, a registration/directory service configured to manage execution of the plurality of core processing application, an event management service configured to monitor occurrence of a predetermined business event, and a flow control service configured to execute a series of steps within a business process.

25. The system of claim 15 wherein the data service module is configured to provide real-time data update and retrieval into and out of data storage elements within the system.

26. The system of claim 25 wherein the data service module is further configured to include a plurality of data stores configured to store data, a data repository configured to store shared components within the system, a data access layer configured to perform a plurality of data handling functions including data extraction, transformation and reformatting, and a data access facility configured to allow a user to access the data access layer.

27. The system of claim 15 wherein one or more of the plurality of core processing applications are capable of being invoked by a plurality of engagement modes.

28. The system of claim 27 wherein the plurality of engagement modes include a batch engagement mode, an interactive engagement mode and an event engagement mode.

29. A method implementing a computerized infrastructure for processing credit card related transactions, comprising:
providing a base platform layer having a plurality of technology platforms configured to support the computerized infrastructure;
providing an access layer configured to provide a plurality of access services;
providing a system services layer configured to provide a plurality of system services to insulate the access layer from the base platform layer; and
providing a plurality of core processing applications that are accessible through the access layer using one or more of the plurality of access services; and
providing a plurality of business applications each configured to access one or more of the plurality of core processing applications via the access layer.

30. The method of claim 29 wherein the plurality access services includes right-time management services, application services, presentation services, insulation services and data services.

31. The method of claim 29 wherein the step of providing the access layer further comprises:
configuring the right-time transaction management services to manage execution of a request for access to one or more of the plurality of core processing applications.

32. The method of claim 31 wherein the step of configuring the right-time transaction management services further comprises:
providing a continuous availability management service, a workload management service, a unit-of-work management service, a fault management service, a scheduling/calendar management service and a logging/tracing service.

33. The method of claim 29 wherein the step of providing the access layer further comprises:
configuring the application services to optimize use of application code across the computerized infrastructure.

34. The method of claim 33 wherein the step of configuring the application services further comprises:
configuring a plurality of components and engines to be used or shared by the plurality of access services and the plurality of core processing applications;
configuring a security/authorization service to regulate access to the plurality of access services and the plurality of core processing applications;
configuring an auditing/journaling service to maintain historical logs and data relating to events which occur during execution of one of the plurality of access services or one of the plurality of core processing applications; and
configuring a time service to maintain common representation of time and date across the plurality of core processing applications.

35. The method of claim 29 wherein the step of providing the access layer further comprises:
configuring the presentation services to allow a core processing application to be accessed and presented to a plurality of clients using different interface methods.

36. The method of claim 35 wherein the step of configuring the presentation services further comprises:
configuring a plurality of interface gateways to provide access to the plurality of core processing applications;
configuring a security/cryptography service to secure information exchanged between the computerized infrastructure and a client;
configuring a plurality of common user interface facilities to provide a common look and feel across the plurality of core processing applications; and
configuring a security/authentication service to provide client authentication and validation when the client signs onto the computerized infrastructure.

37. The method of claim 29 wherein the step of providing the access layer further comprises:
configuring the insulation services to facilitate communications amongst the plurality of access services and the plurality of core processing applications.

38. The method of claim 37 wherein the step of configuring the insulation services further comprises:
configuring a distribution service to manage invocation of one of the plurality of core processing application;
configuring a connection management service to allow the plurality of core processing applications to interact with one another;
configuring a registration/directory service to manage execution of the plurality of core processing application;
configuring an event management service to monitor occurrence of a predetermined business event; and
configuring a flow control service to execute a series of steps within a business process.

39. The method of claim 29 wherein the step of providing the access layer further comprises:
configuring the data services to provide real-time data update and retrieval into and out of data storage elements within the computerized infrastructure.

40. The method of claim 29 wherein the step of configuring the data services further comprises:
configuring a plurality of data stores to store data;
configuring a data repository to store shared components within the computerized infrastructure;
configuring a data access layer to perform a plurality of data handling functions including data extraction, transformation and reformatting; and
configuring a data access facility configured to allow a user to access the data access layer.

41. The method of claim 29 further comprising:
invoking one or more of the plurality of core processing applications using a one or more of a plurality of engagement modes.

42. The method of claim 41 wherein the plurality of engagement modes include a batch engagement mode, an interactive engagement mode and an event engagement mode.
